(19) United States
(12) Patent Application Publication
(10) Pub. No.: US 2007/0220846 A1
(43) Pub. Date: Sep. 27, 2007

(54) Enclosed portable work station

(76) Inventor: Jeremy Ray, Louisville, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/389,272

(22) Filed: Mar. 24, 2006

(51) Int. Cl. B01D 50/00

(52) U.S. Cl. 55/385.2

(57) ABSTRACT

An enclosed booth having an adjustable height and accommodating at least one worker is disclosed. The adjustable height of the booth allows it to contact a ceiling, and a portal in the top of the booth can be opened while the booth is in contact with the ceiling. The worker can then remove tiles and work above the ceiling. The enclosed nature of the booth prevents dust and contaminated air from reaching the surroundings. The booth has an upper and lower portion. The height of the booth is adjusted by changing the position of the upper portion with respect to the lower portion. A flexible covering between the top of the upper portion and the lower portion keeps the booth interior enclosed and powered means are provided to adjust the upper portion to infinite number of positions. Other features add to the utility of the booth.

### FIELD OF THE INVENTION

This invention relates generally to portable workstations intended to provide a barrier between a ceiling recess and the surrounding environment when the ceiling recess is accessed. Specifically, the invention provides an enclosed, telescoping booth that can accommodate at least one worker, telescope to press against a drop ceiling, and contain the dust and air exposed when the worker removes panels from the drop ceiling to access the area above the drop ceiling for work and inspection.

### BACKGROUND OF THE INVENTION

Many buildings have drop ceilings which segregate an upper recess from the occupied space of the building. Water pipes, electrical conduit, lighting, communication lines, etc. may be enclosed in the area above a drop ceiling and this keeps these systems separated from the occupants of the building. This normally unseen space is not maintained in a highly clean fashion, as it is very seldom accessed, so when it is accessed, it presents problems of hygiene for the occupied areas of the building. This is particularly true in hospitals, health care facilities, or other areas requiring a cleaner than usual environment. With today's increased concern about communicable diseases, as well as diseases that are not bacteria or virus based, but may be caused by other elements such as asbestos, the desire to prevent contamination of occupied areas has increased. Because these systems in the recessed area of the ceiling may need repair, maintenance, or even installation, this area cannot be considered inherently sealed to the occupied area. In addition to maintenance, with the retrofitting of network systems into buildings, it is not uncommon to have cables and other items relating to computer networks being run through these areas above the occupied space of buildings. This requires access to the ceiling along multiple locations, and in situations where work is being done, it is necessary that this access be reasonably quickly gained, while not allowing dust and other debris from above the drop ceiling into the occupied space.

There are several issues that need to be addressed to have an effective system. One issue is that the interior of the booth should be shielded from the occupied building space even when it is not engaged against the ceiling. Another issue is the ability to press against ceilings of many different heights. Still another issue is the degree of difficulty of adjusting to the ceiling height. Other issues include; treating the air in the booth, electrical and power systems for the booth, containment of liquid spills, booth contours for working near walls, as well as still other issues.

### DESCRIPTION OF THE PRIOR ART

The need to provide some barrier between the occupied space of a building and the recessed spaces above a drop ceiling while work is performed in the recess has been recognized, and several inventors have attempted to provide remedies for this need. U.S. Pat. No. 4,682,448 by Healey claims a booth having an adjustable frame. The frame is covered by a flexible covering and is capable of discreet, incremental, adjustments in height. The flexible covering allows entry into the interior of the booth via zippers. The booth height may be adjusted up to the ceiling so that the top of the booth is near the tiles and a worker in the booth can lift out the drop ceiling tiles to work above the drop ceiling. Access to the ceiling from the booth is accomplished through a zippered opening. Healey provides for the connection of a vacuum hose which would create a negative air pressure within the booth and draw any dust particles or other contaminates to the vacuum, or at least prevent the dust from drifting out into the occupied area of the building. While providing some margin of shielding between the work area and the occupied part of the building, Healey's incremental adjustments mean that in some situations, the frame will not seal closely to the drop ceiling. Also, the adjustments must be made by hand without any sort of mechanical assistance.

U.S. Pat. No. 4,765,352 and U.S. Pat. No. 5,558,112 are among several patents by Strieter. The enclosures in Strieter provide a frame with an adjustable portion, as well as some additional features. Part of the enclosure has firm walls while the upper part of the enclosure has flexible walls conducive to adjustment. The upper portion of Strieter can adjust to the height of the space within which it is working. A difference between the two cited Strieter patents is what surface is being accessed. In one case, U.S. Pat. No. 4,765,352, the enclosure has an open top, so that when the frame is adjusted up to the ceiling, the open top gives access to the drop ceiling and above. In the other Strieter patent cited, U.S. Pat. No. 5,558,112, it is a sidewall which is removed, so that a worker in the enclosure can clean a vertical surface or a wall. A feature common to the Strieter patents is an opening, a chute, and a bag attached at the end of the chute or over the opening. This is intended for applications where a worker is removing asbestos from a ceiling area, and it provides a means for disposing of asbestos as it is removed from the ceiling without allowing it to go out into the occupied area. Another characteristic common to the Strieter patents, as well as the previously mentioned Healy patent, is the incremental adjustment of height provided by the frames. Again, this incremental adjustment may not fit different ceiling heights well. This can be a major drawback to these inventions. Strieter also provides for a means of creating a negative pressure within the cell or enclosure.

U.S. Pat. No. 5,080,701 by Howard et al is also directed to providing an enclosed workspace for working above a drop ceiling. Howard has a lower booth portion with provision for entry by an occupant and an extendable framework above this lower booth portion. A flexible covering around this upper extendable framework allows the interior of the booth to remain shielded while the upper framework moves up and down. In addition to this extendable upper framework, there is a second extendable framework in Howard. This second extendable framework actually extends up into the recessed area above the drop ceiling. This second extendable area can be adjusted down to a smaller size than the first extendable frame. This allows the first extendable frame to press against the drop ceiling, while the smaller adjustable frame can extend up through the drop ceiling through a smaller hole where removable tiles have been removed. Beneath the floor of the lower booth area is a space for carrying some of the mechanical attributes of Howard. These include ventilation and vacuuming system elements.

U.S. Pat. No. 6,383,242 B1 by Rogers, et al is a work cell providing an elevated platform as well as contact with the drop ceiling. This leads to a structure also having essentially three frames. There is a bottom frame which has four posts with wheels on the end of them for movement upon the ground and a bottom panel spanning these four posts. On this bottom panel are located mechanical elements such as those for ventilation and filtration. The next, or middle, frame rides upon the four posts just mentioned, and also has a panel spanning the four posts. This panel is the floor upon which an occupant may stand while working and this second frame is adjustable to different heights above the lower frame. This moves the worker up higher toward the ceiling when needed. A third frame fitting within the second frame has an essentially continuous upper perimeter running around four posts operatively associated with the previously mentioned second frame. This upper frame can extend up to the drop ceiling, and carries a flexible covering, which covers the sides of the entire structure. This flexible covering hangs up over the perimeter of the top frame, and down around the rest of the apparatus. Rogers' adjustments of the frame are accomplished by matching holes in the lower two sets of frames. The frames are elevated to where the holes line up and pegs are inserted through the holes to maintain the height relationship between the frames. The uppermost frame is secured in its position by locking screws at the four posts. These screws are threaded through the second frame. The upper frame is moved to the desired position and the screws are tightened down upon the posts of the upper frame.

### SUMMARY OF THE INVENTION

The present invention comprises a booth having an adjustable height capable of reaching a ceiling and pressing against the ceiling. The booth has two main portions, a lower portion resting upon the floor and an upper portion associated with the lower portion. This upper portion can extend and retract vertically with regard to the lower portion, and it is the movement of the upper portion with respect to the lower portion that gives the booth its adjustable height. An occupant can gain access to the interior of the booth via a door or portal. A flexible covering attached to the lower portion and the upper end of the upper portion allows the adjustment of the height of the booth without exposing the interior of the booth to its surroundings. This flexible covering can be seen through for convenience and safety. Also, the top of the upper portion has a covering over it which can be opened from the inside and allows the interior of the booth to remain separated from its surroundings when the top of the upper portion is not pressed up against the ceiling. This covering may be opened from the inside, when the top of the upper portion is pressed against the ceiling.

The booth, having a lower portion and an upper portion, is positioned beneath a desired location, and a worker enters it. The upper portion may then be extended up until it contacts a ceiling. The occupant may then open the covering across the top of the upper portion and remove ceiling panels to access the area above the drop ceiling. The booth can accommodate a ladder for this purpose.

The upper portion may be adjusted to an infinite number of positions between full extension and full retraction with respect to the lower portion. The ability to adjust to an infinite number of positions is desirable for contacting ceilings of various heights. This ability is important in order to create and maintain a good seal against a ceiling. It may be accomplished in many different ways. Among these ways are included a cable system driven by an electric winch onboard the booth, or electric motors driving adjusting screws at several locations supporting the upper portion. The winch in the cable system pulls the cables about a spool on the winch to pull the upper portion up out of the lower portion. In the case of the independent motors, the motors drive adjusting screws which would be engaged with matching threads on the upper portion. As the motors turn the screws, the threaded element engaged on the upper portion would move along the screws and move the upper portion to which they are fixed.

Other elements available on different embodiments of the invention include: an onboard battery for powering the lift system; a floor in the booth capable of catching and retaining fluid spills; an onboard recharger for the battery, so that the booth may be parked near a receptacle, plugged in, and the battery charged; laser alignments on the booth showing where the booth would contact the ceiling when the upper portion is raised; an AC outlet system powered by an external extension cord plugged into a standard wall outlet or other external power source; smooth contour of the booth so that it may fit closely against the wall; a filter and fan for filtering the air re-circulated within the booth; a filtered vent to facilitate the raising and lowering of the upper portion of the booth; sound suppression capabilities in the walls and coverings of the work station; heating and cooling elements to control the climate in the enclosed work station; and accommodation in the work station for mounting cable reels, particularly in the door. These additional elements, while not essential to any given embodiment, greatly increase the utility of the booth. This list of elements should not be considered exhaustive, and particular embodiments of the invention intended for specific uses may have additional features tailored to those specific uses.

As discussed above, the method and device of the present invention overcomes the disadvantages inherent in prior art methods and devices. In that respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Accordingly, those skilled in the art will appreciate that the conception upon which this invention is based may readily be utilized as a basis for the design of other structures, methods, and systems for carrying out the several purposes of the present invention. It is important, therefore, that the claims be regarded as including such equivalent constructions insofar as they do not depart from the spirit of the present invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way.

### BRIEF DESCRIPTION OF THE DRAWINGS

Additional utility and features of the invention will become more fully apparent to those skilled in the art by reference to the following drawings.

FIG. 1 shows a first embodiment of the invention.

FIG. 2 shows the first embodiment of the invention with parts of the flexible covering, external walls, and the floor cut away.

FIG. 3 shows a second embodiment of the invention with parts of the flexible covering, external walls, and the floor cut away.

FIG. 4 is a sectional view of a third embodiment of the invention at the plane shown in FIG. 1.

FIG. 5 is a sectional view of a fourth embodiment of the invention at the plane shown in FIG. 1.

### DETAILED DESCRIPTION OF EMBODIMENTS

The detailed description below is intended to explain the current invention. It is to be understood that a variety of other arrangements are also possible without departing from the spirit and scope of the invention. In the descriptions that follow below, where appropriate, the same numbers may be used in different illustrations.

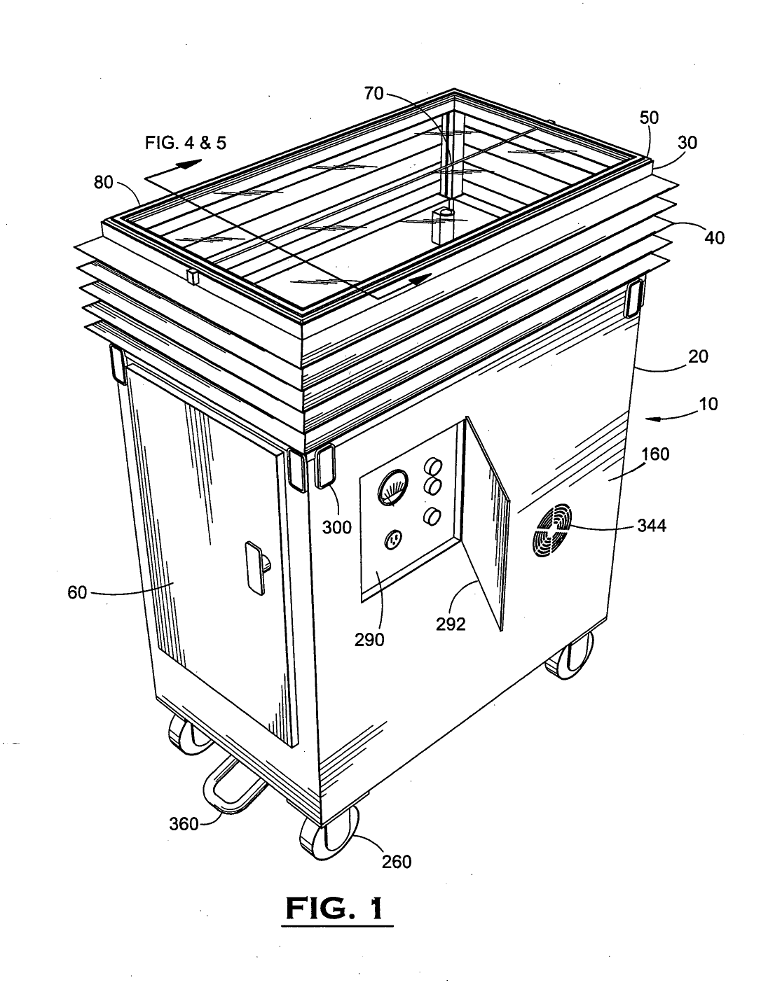

FIG. 1 shows an embodiment of the present invention consisting of an enclosed booth, or enclosed work station, 10 having a lower portion 20 and an upper portion 30. Lower portion 20 rests on the ground, while upper portion 30 is adjustably joined with lower portion 20, so that the overall height of enclosed booth 10 can be changed by vertically adjusting the position of upper portion 30 with respect to lower portion 20. Flexible covering 40 maintains the enclosed environment of enclosed booth 10 while allowing upper portion 30 to move and change the height of enclosed booth 10. This allows the height of enclosed booth 10 to change from its shortest height, when upper portion 30 is fully retracted with respect to lower portion 20, to its greatest height, when upper portion 30 is fully extended with respect to lower portion 20, and to any ceiling height in between those two extremes. Flexible covering 40 can be transparent for convenience and safety. Top cover 50 over the top of upper portion 30 completes the full enclosure of enclosed booth 10.

Door 60 provides a point of entry into enclosed booth 10 for an occupant. Top portal 70 in top cover 50 can be opened to give access to the area above upper portion 30, and can also be transparent for convenience and safety. Top portal 70 can be opened even when upper portion 30 has been raised up into contact with the ceiling above it, and to provide the most overhead access, top portal 70 can comprise the entire top of the upper end of upper portion 30. Therefore, in some embodiments, top portal 70 and top cover 50 will be one and the same. Gasket 80 runs around the top of upper portion 30 to conform to a ceiling and prevent air flow between the ceiling and said top. Door 60 may be located anywhere around lower portion 20. In the embodiment shown, door 60 is located on a short side, or end, of lower portion 20.

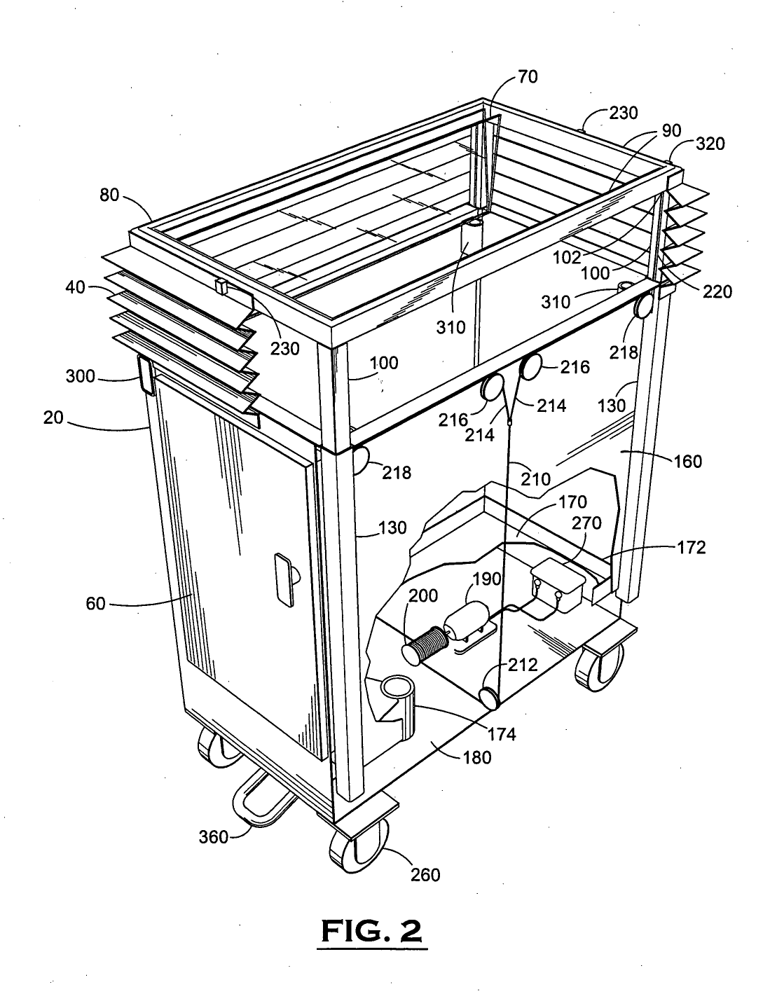

FIG. 2 shows an embodiment of the invention with parts of the flexible covering, side , and the floor cut are away to show structure and accessories. In the embodiment shown in FIG. 2, lower portion 20 and upper enclosed portion 30 have a frame construction. Upper portion 30 is defined by eight sections of structural tubing. Four of these sections define an upper frame 90 and the remaining four each extend down vertically from a different corner of upper frame 90 to form post legs 100 that are operatively associated with lower portion 20. As discussed above, upper frame 90 is covered by top cover 50 and top portal 70, while the sides defined by post legs 100 are covered with flexible covering 40.

The frame of lower portion 20 has four corner posts 130, one at each corner. Other sections of structural tubing combine with corner posts 130 to complete the frame and provide sufficient structural rigidity. The booth sides 160 of the lower portion 20 shown in FIGS. 1-3 are sheet metal but can be of other material as well. The top of the frame of lower portion 20 is open, while an accessory deck 180 spans the bottom of the frame and an occupant floor 170 spans the frame just above accessory deck 180.

Four corner posts 130 are hollow to allow the four post legs 100 of upper portion 30 to insert into corner posts 130. Post legs 100 can move up and down in corner posts 130 and this allows the overall height of enclosed booth 10 to change. Post legs 100 themselves may be hollow, partially hollow, or solid, depending on the particular embodiment.

The presence of two levels, occupant floor 170 and accessory deck 180, provides the large surface of accessory deck 180 for mounting accessories, while keeping occupant floor 170 uncluttered for a working occupant. These accessories may pertain to various systems of enclosed booth 10. One such system is the lift system used to change the extension of upper portion 30 and the height of enclosed booth 10.

In one embodiment, a cable system is used to raise and lower upper portion 30. Elements of the cable system can be seen in FIG. 2 where part of booth side 160 and occupant floor 170 have been removed. Powered winch 190 with cable drum 200 is mounted on accessory deck 180. The cables of the system are actually two symmetrical subsystems, one for each long side of enclosed booth 10. One half of the system may be seen in FIG. 2. Primary cable 210 runs underneath occupant floor 170 from cable drum 200 to floor pulley 212, where it changes to a vertical direction, and runs up booth side 160 toward the upper end of lower portion 20. Near the upper end of lower portion 20, primary cable 210 ends, or splits, into two secondary cables 214. These secondary cables 214 each bend over a splitting pulley 216, which redirects each of them toward a separate corner at the top of lower portion 20. At the corners, secondary cables 214 are again redirected over pulleys, lift pulleys 218, which redirect secondary cables 214 down into separate corner posts 130. Secondary cables 214 run down into corner posts 130 where they attach to the post leg 100 of upper portion 30 inserted into that corner post 130. In the embodiment shown, post legs 100 are solid and each has a groove 220 to accommodate secondary cable 214, while allowing post legs 100 to fit more closely within corner posts 130. Cable drum 200 powers the cable system by taking up primary cable 210 which pulls down secondary cables 214. These pass over splitting pulleys 216 and lift pulleys 218 and pull up on post legs 100 to change the position of upper portion 30 with respect to lower portion 20. This cable system allows upper portion 30 to adjust to an infinite number of positions between its full retraction and full extension. This allows it to adjust to any ceiling height within that range and achieve positive contact with the ceiling to achieve a good seal between the top of upper portion 30 and the ceiling. Sensors 230, located on the top of upper portion 30, sense the contact with the ceiling and cut off power to powered winch 190.

The cable systems are flexible in their layouts and the layout just described and shown in the figures should not be considered limiting on the current invention. It is conceivable that four distinct cables could run underneath the occupant floor directly to the corner posts. Another alternative would be to run the cable up through the corner posts and then back down to the post legs after looping over a pulley at the top. Many different routes could be used to run the cables.

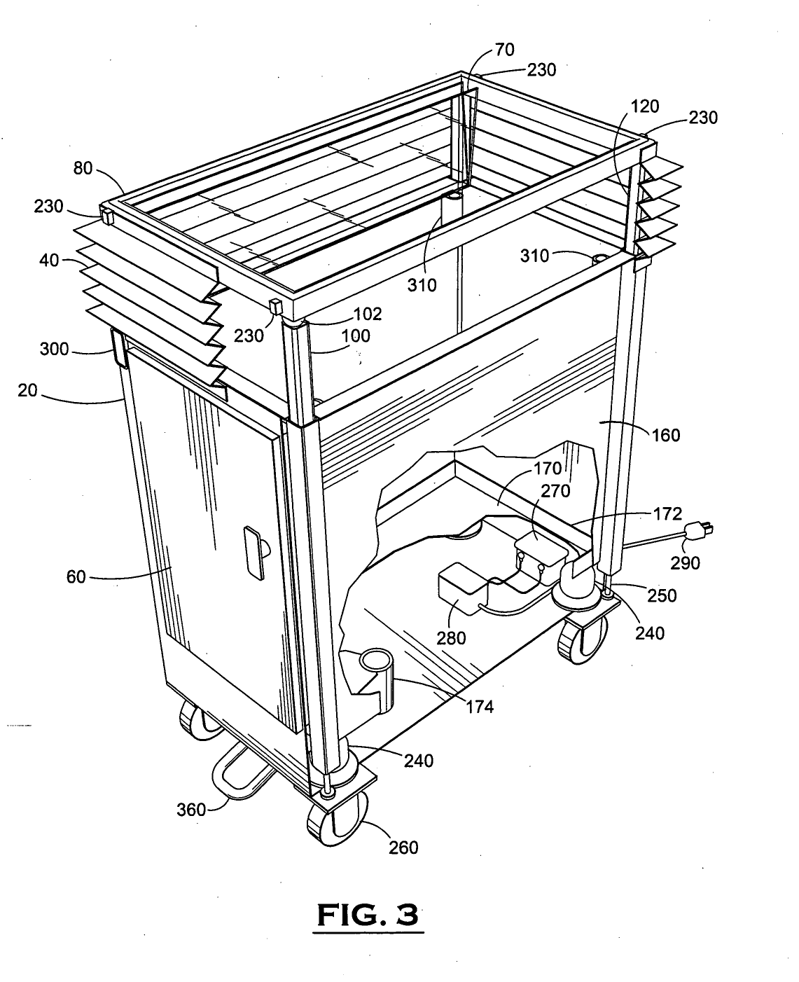

An alternative embodiment of enclosed booth 10 uses a different powered system to move upper portion 30. Lift is provided by screws at each corner post powered by separate motors. This system may be seen in FIG. 3. Motors 240 are located on accessory deck 180 beneath each corner post 130. Motors 240 turn screws 250 which are engaged with post legs 100 of upper portion 30 to move upper portion 30 with respect to lower portion 20. In this embodiment, the joints 102 where the members of upper frame 90 and post legs 100 meet, can be flexibly held together by pins, ball joints, or other means, so that post legs 100 need not remain perfectly perpendicular to upper frame 90. In this embodiment, a sensor 230 located at each corner of upper frame 90, would cut off power to the motor 240 directly below it when the sensor 230 contacts the ceiling, even though other motors 240 may continue to run. Therefore, this embodiment, with flexible joints 102, can adjust to ceilings and floors that are not necessarily parallel to each other, in addition to the infinite linear positions between full retraction and full extension. The nature of flexible covering 40 maintains the barrier between the inside and outside of booth 10. An embodiment that uses independent motors 240 to raise and lower upper portion 30 may have a different frame structure to accommodate the motors 240 at the corners.

In FIG. 2 and FIG. 3, the operation of one embodiment of top portal 70 is shown. Top portal 70 takes up almost the entire area of top cover 50, is hinged along one side to upper portion 30, and has a second, parallel, hinge down its middle dividing it into two panes. When opened, the middle hinge of top portal 70 swings down inside of upper portion 30 while the free side of top portal 70 rides in a track. Top portal 70 then folds nearly flat to one side of upper portion 30. In this particular embodiment, folding down and to the side of upper portion 30 allows top portal 70 to open even when the top end of upper portion 30 is pressed up against the ceiling. Of course, there are many types of doors that could be used as a portal and still be capable of opening to the inside of upper portion 30. These possibilities include: a single pane that swings down into upper portion 30; two separate panes hinged along opposing sides of upper portion 30 and meeting in the middle; and a multi-section cover that rides in a track and rolls up at one side of upper portion 30. These and other approaches could be taken for a top portal and still be within the scope of the currently claimed invention.

For greatest utility, enclosed booth 10 needs mobility. To that end, wheels 260 are located on the bottom of lower portion 20 to provide that mobility. Wheels 260 can have several arrangements. All the wheels 260 may swivel for the most free motion or wheels 260 can be like those of a typical automobile where two wheels pivot for steering and two wheels are in fixed orientation with respect to lower portion 20 to provide directed motion.

In the embodiments shown, powered winch 190 and independent motors 240 are battery powered. Returning to FIG. 2 and 3, battery 270 is mounted on accessory deck 180. As shown in FIG. 3, battery charger 280, also located on accessory deck 180, provides a way of recharging battery 270. Charger cord 290 extends from enclosed booth 10 to plug into a typical AC wall socket to recharge battery 270. Of course, if a powered wall socket is not available, other sources such as a portable generator would do just as well.

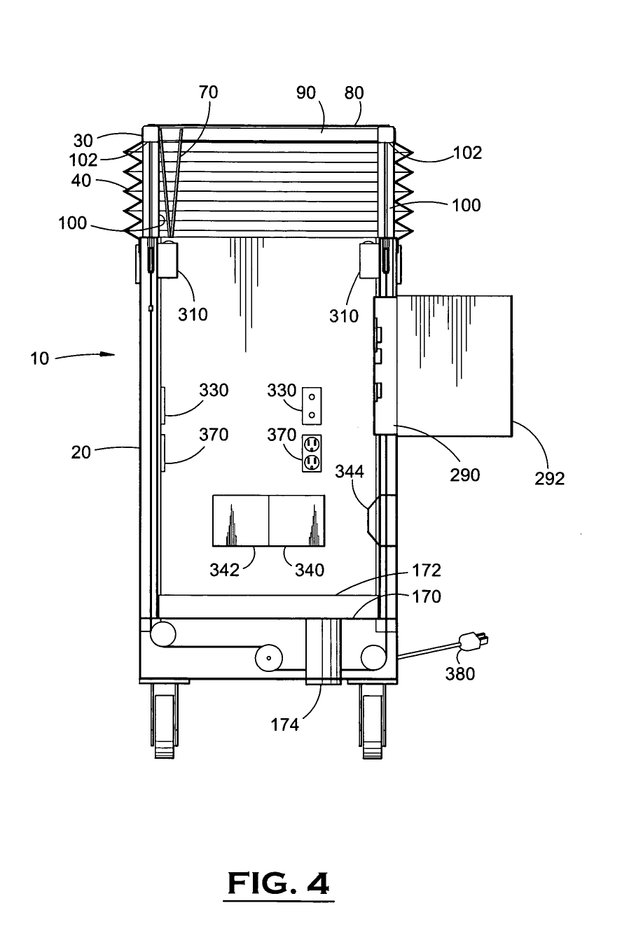

In addition to powered winch 190, enclosed booth 10 may have other electrical elements. Referring to FIG. 1, flashers 300 are blinking lights visible on the external walls of enclosed booth 10. Flashers 300 make enclosed booth 10 highly visible. This is highly important in large facilities where traffic includes small motorized vehicles, as well as pedestrians. Such facilities, might include airports and large hospitals, among others. In FIG. 3, work lamps 310 are mounted around upper frame 90 and are directed upward. When on, work lamps 310 illuminate the space above enclosed booth 10, including the space above a drop ceiling when tiles have been removed and a worker is working in that space. Optionally, lasers 320, seen in FIG. 2, can be attached to the top of upper portion 30 and directed upward to indicate where upper portion 30 will contact a ceiling when raised to that height. These lasers 320 are powered by battery 270 as well. Battery 270 also provides DC power to several DC power sockets 330, shown in FIG. 4, located about enclosed booth 10 for DC powered devices such as lights with cords that plug into DC power sockets 330. The lights could be placed up into the space above the drop ceiling or other workspaces to provide better lighting. Any desirable DC powered device could also be hardwired to receive power from battery 270 or an AC to DC converter.

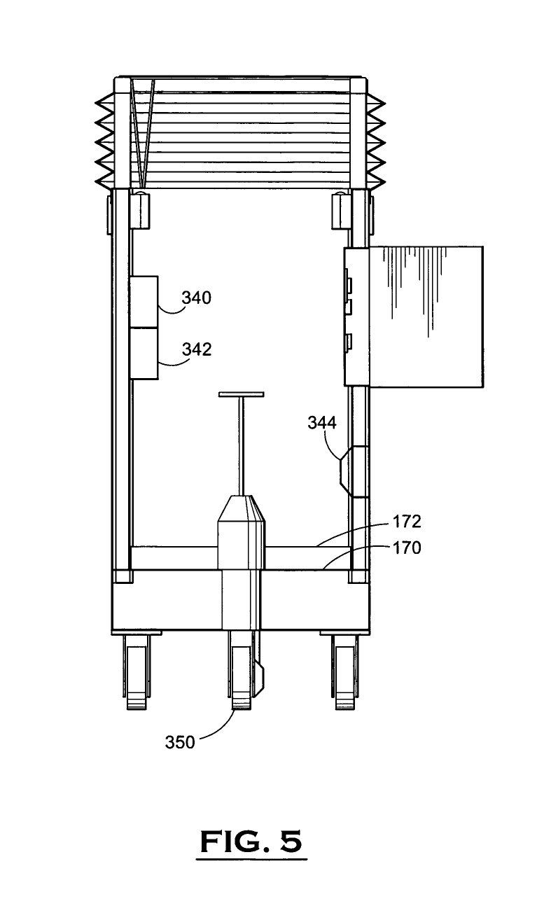

While a worker has upper portion 30 in contact with a ceiling, top portal 70 opened, the ceiling opened for access, and is working in the space above the ceiling, it is almost inevitable that contaminants will enter enclosed booth 10 from the overhead space. Filter 340 and fan 342, shown in FIG. FIG. 4, remove these contaminants from the air. Filter 340 may be a High Efficiency Particulate Air, or HEPA, filter. Fan 342 is powered by battery 270, and although they are shown in FIG. 4 on a short wall of enclosed booth 10, filter 340 and fan 342 are modular and can be located in many different places in enclosed booth 10. FIG. 5 shows filter 340 and fan 342 in an alternative location. It should also be noted that filter 340 and fan 342 are located completely inside of enclosed booth 10. This keeps the outside of enclosed booth 10 free of obstructions when trying to place enclosed booth 10 near a wall or other tight spot. However, the modular nature of filter 340 and fan 342, mean that they could protrude from enclosed booth 10 if that were preferred.

Some environments may be much more sensitive to the repeated opening and closing of door 60 when an occupant exits enclosed booth 10 to reposition it. For such environments, FIG. 5 shows enclosed booth having a motorized wheel 350 in addition to passive wheels 260 previously discussed. From within enclosed booth 10, motorized wheel 350 can be pivoted in any direction to steer as well as move enclosed booth 10. In the embodiment shown, motorized wheel 350 is powered by battery 270.

In some applications where repeated opening and closing of door 60 by an occupant is not an issue, it may be preferred to have powered assistance in moving enclosed booth 10. FIG. 1-3 show tow bar 360 for those situations. An external tow motor can hook up to tow bar 360 to move enclosed booth 10 with less exertion.

Of course, persons performing work often use AC powered tools. For such tools, enclosed booth 10 also has AC power outlets 370 located in several places, as shown in FIG. 4. AC power outlets 370 convey electricity from a standard wall outlet via a power cord 380 extending from enclosed booth 10. Power cord 380 may be the same power cord 290 that powers battery charger 280 or it may be an entirely separate cord. If battery charger 280 and AC power outlets 370 are powered by the same electrical cord, various switching means could be employed to allow battery charger 280 and AC power outlets 370 to be powered together or separately.

The various electrical elements of enclosed booth 10 will have their own wiring and fusing requirements. These are accommodated in panel box 290 shown in FIG. 1. Panel box 290 is accessible from electrical door 292 which opens to the outside of enclosed booth 10. To maintain an obstruction free exterior, panel box 290 is recessed into a booth side 160 and intrudes slightly into the interior of enclosed booth 10. This may be seen in the section view presented by FIG. 4. Ground Fault Interrupts “GFI's” are included in the electrical system for safety.

Along with planned repairs and maintenance, emergency repairs are often necessary. These may result from plumbing or other fluid leaks. Returning to FIG. 2, showing occupant floor 170, it can be seen that occupant floor 170 is shaped like a pan, having its edges 172 upturned. This allows occupant floor 170 to function as a catch basin when positioned beneath a fluid leak with top portal 70 opened. Drain 174 facilitates the emptying of occupant floor 170.

Passive filter vent 344 can be seen in FIG. 4 and its ports to the outside can be seen in FIG. 1. Filter vent 344 may also have High Efficiency Particulate Air, or HEPA, filter capabilities. Filter vent 344 allows air to flow in and out of enclosed booth 10 when upper enclosed portion 30 is raised and lowered. Enclosed booth 10 is well sealed at top portal 70, door 60 and at any other port for wiring, etc. The movement up and down of upper portion 30 displaces a significant amount of air. Filter vent 344 allows the passage of air to facilitate the adjustment of upper portion 30 but prevents contaminants from escaping booth 10 to the surroundings.

Enclosed booth 10 has significant application in the wiring of buildings, particularly remedial computer networking. For wiring applications, booth 10 would have additional apparatus for accommodating wire reels for the significant amount of wiring and cables needed for such applications. There are several ways available to accommodate the reels, including locating mounts on or in door 60. If the mounts are located in door 60, door 60 would have to be constructed with sufficient depth to partially contain the reels. If the mounts are on door 60, clearances sufficient for the motion of the door would have to be provided. Regardless of the particular method used to accommodate the reels, this would not remove the embodiment from the scope of this application.

Enclosed booth 10 may be used in a wide range of environments. These environments external to enclosed booth 10 may cause the interior environment of enclosed booth 10 to exceed the normal comfort range for an occupant. Typical climate controls for heating and cooling may be used to extend the range of operation of enclosed booth 10. These elements are self contained and the specific location within enclosed booth 10 of these elements may vary without removing the embodiment from the scope of this application.

As enclosed booth 10 may be employed in hospitals or other businesses during hours when others may be nearby, work noise may be an issue. Typical sound suppression methods may be employed in the walls and coverings of enclosed booth 10 to reduce the amount of noise allowed out to the general environs. Likewise, these added elements are within the scope of the present application.

Having provided detailed descriptions, it should be noted that there are many ways to vary the elements of these embodiments and remain within the spirit and scope of the present invention. There are many ways to provide powered lift to upper portion 30, as well as many types of doors or portals that could be used for top portal 70. Also the arrangement of the wheels, battery, vents, fan and filter, lights, etc. provide opportunity for variation without leaving the scope of this invention. It should be obvious from this that there are numerous embodiments subsumed in the present invention and the scope of this invention should not be limited by the discussion of the embodiments above.

I claim:

1. An enclosed portable work station comprising:
a) a lower portion;
b) an upper portion operably associated with said lower portion and capable of extending and retracting with respect to said lower portion;
c) a flexible covering surrounding said upper portion and extending from the upper end of said upper portion to said lower portion;
d) a covering over said upper end of said upper portion, said covering being capable of being opened even when said upper end of said upper portion is up against a ceiling, and;
e) means of vertically adjusting said upper portion to an infinite number of positions from full extension to full retraction.

2. An enclosed portable work station as in claim 1, further comprising:
an onboard battery for electrical systems.

3. An enclosed portable work station as in claim 1, wherein:
said means of adjusting the vertical position of said upper portion is a cable system driven by a powered winch.

4. An enclosed portable work station as in claim 1, wherein:
said means of adjusting the position of said upper portion utilizes independent electric motors driving separate adjusting screws.

5. An enclosed portable work station as in claim 1, further comprising:
a filter and fan to filter and re-circulate air within said enclosed portable work station.

6. An enclosed portable work station as in claim 1, further comprising:
a floor section in said lower portion shaped to catch and contain fluids from overhead spills or leaks.

7. An enclosed portable work station as in claim 1, further comprising:
at least one laser directed vertically upward to indicate where said upper portion would contact a ceiling when raised to that height.

8. An enclosed portable work station as in claim 1, further comprising:
lights directed upward to illuminate overhead workspace.

9. An enclosed portable work station as in claim 2, further comprising:
at least one DC power socket powered by said battery.

10. An enclosed portable work station as in claim 1, further comprising:
at least one AC power outlet powered by an extension cord running from said work station to an AC power source.

11. An enclosed portable work station as in claim 1, further comprising:
means of heating and cooling for climate control within said enclosed portable work station.

12. An enclosed portable work station comprising:
a) a lower portion;
b) an upper portion operably associated with said lower portion and capable of extending and retracting with respect to said lower portion;
c) a flexible covering surrounding said upper portion and extending from the upper end of said upper portion to said lower portion;
d) a covering over said upper end of said upper portion, said covering being capable of being opened even when said upper end of said upper portion is up against a ceiling, and;
e) powered means of adjusting said upper portion from full extension to full retraction.

13. An enclosed portable work station as in claim 12, further comprising:
an onboard battery for electrical systems.

14. An enclosed portable work station as in claim 12, wherein:
said means of adjusting the vertical position of said upper portion is a cable system driven by a powered winch.

15. An enclosed portable work station as in claim 12, wherein:
said means of adjusting the position of said upper portion utilizes independent electric motors driving separate adjusting screws.

16. An enclosed portable work station as in claim 12, further comprising:
a filter and fan to filter and re-circulate air within said enclosed portable work station.

17. An enclosed portable work station as in claim 12, further comprising:
a floor section in said lower portion shaped to catch and contain fluids from overhead spills or leaks.

18. An enclosed portable work station as in claim 12, further comprising:
at least one laser directed vertically upward to indicate where said upper portion would contact a ceiling when raised to that height.

19. An enclosed portable work station as in claim 12, further comprising:
lights directed upward to illuminate overhead workspace.

20. An enclosed portable work station as in claim 13, further comprising:
at least one DC power socket powered by said battery.

21. An enclosed portable work station as in claim 12, further comprising:
at least one AC power outlet powered by an extension cord running from said work station to an AC power source.

22. An enclosed portable work station as in claim 12, further comprising:
means of heating and cooling for climate control within said enclosed portable work station.
